(19) United States
(12) Patent Application Publication
(10) Pub. No.: US 2018/0074021 A1
(43) Pub. Date: Mar. 15, 2018

(54) DEVICE AND METHOD DETERMINING SCALE THICKNESS ON NON-HEATED SURACES IN FLUID PROCESS APPLICATIONS

(71) Applicant: Solenis Technologies, L.P., Schaffhausen (CH)

(72) Inventors: Terry L. Bliss, Wilmington, DE (US); Timothy F. Patterson, Wilmington, DE (US)

(21) Appl. No.: 15/699,408

(22) Filed: Sep. 8, 2017

Related U.S. Application Data
(60) Provisional application No. 62/394,888, filed on Sep. 15, 2016.

(51) Int. Cl. G01N 29/07; G01N 19/08; G01N 29/04; G01S 15/46; G01S 15/02; G01S 7/523

(52) U.S. Cl. CPC G01N 29/07; G01N 19/08; G01N 29/041; G01S 2015/465; G01S 15/025; G01S 7/523; G01S 15/46

(57) ABSTRACT

Provided is a device and method of determining the thickness of accumulating scale on surfaces exposed to a liquid media. More particularly, it is a method for determining the comparable accumulation of scale such as, calcium or magnesium and carbonate, oxalate, sulfate, or phosphate scale, on cold or hot surfaces in water process applications.

This application claims the benefit of U.S. provisional application No. 62/394,888, filed 15 Sep. 2016, the entire contents of which are hereby incorporated by reference.

### BACKGROUND

The present invention provides for a method of determining the thickness of accumulating scale on surfaces exposed to a liquid media. More particularly, the present invention relates to determining the comparable accumulation of scale such as, calcium or magnesium and carbonate, oxalate, sulfate, or phosphate scale, on heated or non-heated surfaces in industrial water process applications, for example, cooling towers, heat exchangers and evaporative equipment such as those found in industrial and regulated markets, through the use of ultrasonic signals.

Scaling formation arises primarily from the presence of dissolved inorganic salts in the aqueous system that exists under supersaturation conditions of the process. The salts are formed when the liquid, which is often water, is heated or cooled in heat transfer equipment such as heat exchangers, condensers, evaporators, cooling towers, boilers, and pipe walls. Changes in temperature or pH lead to scaling and fouling via the accumulation of undesired solid materials at interfaces. The accumulation of scale on heated surfaces cause the heat transfer coefficient to decline with time and will eventually, under heavy fouling, cause production rates to be unmet. Ultimately, the only option is often to shut down the process and perform a cleanup. This requires a shut down in production as well as use of expensive chelating agents or corrosive acids. The economic loss due to fouling is one of the biggest problems in all industries dealing with heat transfer equipment. Scaling is responsible for equipment failures, production losses, costly repairs, higher operating costs, and maintenance shutdowns. Scale can cause non-heat transfer issues, including valve or rotating equipment jamming, wear on close clearance surfaces due to abrasion from scale, corrosion due to scale related biological activity, and such.

In some of the current methods used for measuring scale build-up in processes without heat transfer, a resistance temperature detector (RTD) is mounted within a probe that also contains an ultrasonic transmitter-receiver. The RTD is used to measure bulk water temperature more or less at the point where and the time when the ultrasonic thickness measurement is made. Then, an internal algorithm (i.e., a mathematical model) is used to correct for changes in the speed of sound through water or other liquid media due to bulk or process liquid temperature changes. However, this estimation of ultrasonic velocity vs. temperature may not be sufficiently accurate and is only a partial correction, since changes in the liquid media, such as salinity, can impact liquid media density and hence the speed of sound waves through the liquid media. Process liquid and fluid are used interchangeably throughout the application. Process fluid and liquid also refers to hereinafter to industrial fluids and liquids.

Ultrasonic measurement methods used today fail to take into account the liquid density differences caused by varying salinity, resulting in erroneous scale thickness indications. Some of the newer ultrasonic scale measuring devices measure temperature and conductivity as a predictor of ultrasonic velocity, but the best available models of ultrasonic velocity in water that incorporate temperature and conductivity are not sufficiently accurate for good ultrasonic scale thickness measurement. A popular proposed application of the device is on industrial cooling towers or self-scaling processes, where large changes in conductivity or density or salt composition are to be expected. In a self-scaling environment, by definition, the concentration of the scale-forming salts are at or above their solubility limits. In this case, the water density and hence the ultrasonic velocity is impacted by both the conductivity (a proxy measurement for salt concentration) and also by the nature of the salinity (different ionic species impact conductivity to a different extent at equal ppm), in addition to the temperature effect.

U.S. Pat. No. 4,872,347, relates to an automated ultrasonic examination system for heat transfer tubes for scale thickness measurements. However, the method involves insert tubes adapted to be placed into a cylindrical header and includes a tube moving device, a water pump, cables, an ultrasonic probe and ultrasonic examination unit.

An article published for the in ECNDT 2006-Mo.2.8.3, Ultrasonic Thickness Measurement of Internal Oxide Scale in Steam Boiler Tubes, by Labreck, Kass and Nelligan; discusses measuring the thickness of internal oxide scale in steam boiler tubes using ultrasonic techniques. However, this method uses an oscilloscope as a means of measuring an ultrasonic wave or acoustic signal, and has limited sensitivity. The minimum detectable scale thickness is 125 μm to 250 μm, which would cause a very extreme reduction in heat transfer in cooling water applications. The present invention is capable of detecting scale less than 2-3 μm thick.

General Electric, Inspection Technologies, published a sales bulletin in 2006 (see ge.com/inspection technologies), outlining oxide scale measurement using ultrasonic techniques. Much like the technique immediately above, it is based on the difference between signals reflected from the steel/scale interface and the tube inside diameter and specifies a minimum scale thickness measurement capability of 130 μm. Again this detection capability is significantly less than that for the present invention.

Another paper, “Ultrasonic Technique for Measuring the Thickness of Scale on the Inner Surfaces of Pipes”, K. Lee, Journal of the Korean Physical Society, Vol. 56, No. 2, February 2010, pp. 558-561, discloses measuring the thickness of scale on the inner surfaces of pipes in-situ. However, the technique cannot be used to measure scale formed on the surfaces of a steel pipe.

The company SensoTech, Steinfeldstraβe 1, 39179 Barleben, Germany, manufactures measurement devices that measure ultrasonic velocity in continuous processes. These devices consist of an ultrasonic in-line concentration analyzer that uses time of flight of an ultrasonic signal between a transmitter and a receiver to measure the concentration of miscible liquids in each other and which uses signal attenuation to detect suspended solids particles. These devices use a single ultrasonic transmitter-receiver assembly and are principally used in detecting phase changes and determining concentration, not for measuring scale layer thickness or providing a corrective signal to another ultrasonic measurement system.

Other devices currently being used can measure scale across a 1-way distance of about 16 millimeters (mm) to about 36 millimeter.

However, none of the methods discussed above allow for real-time measuring of high accuracy scale build-up in liquid processing plants. The current method addresses the need for accurate real-time measurement of scale build-up in liquid processing facilities.

### SUMMARY

Provided is a device for determining scale build-up on a heated surface predisposed to scale build-up. The device includes a first or measurement ultrasonic transmitter-receiver assembly having an ultrasonic transmitter-receiver flush surface, wherein the measurement ultrasonic transmitter-receiver assembly is capable of transmitting and receiving an ultrasonic signal through a process fluid or liquid. The device includes a heated target assembly having a heated target scale accumulation surface wherein the transmitted ultrasonic signal is reflected off of the heated target scale accumulation surface or off of a scale build-up on the heated target scale accumulation surface and back to the ultrasonic transmitter-receiver flush surface. There is a second or reference ultrasonic transmitter-receiver assembly having an ultrasonic transmitter-receiver flush surface, wherein the reference ultrasonic transmitter-receiver assembly is capable of transmitting and receiving an ultrasonic signal through the same industrial fluid as the measurement ultrasonic signal; and an unheated, scaling resistant ultrasound reflecting surface. The unheated, scaling resistant ultrasound reflecting surface is at a known and fixed distance from the reference ultrasonic transmitter-receiver flush surface. The device also includes one or more signal processors for measuring the transit time for the ultrasonic signal to travel the known distance from the reference ultrasonic transmitter-receiver assembly through the process fluid to the unheated, scaling resistant ultrasound reflecting surface and back through the process fluid to the reference ultrasonic transmitter-receiver which is used along with the known separation distance to calculate the real time velocity of the ultrasonic signal through the process fluid; and also measures the transit time for the ultrasonic signal to go from the measurement ultrasonic transmitter-receiver assembly through the process fluid to the heated target scale accumulation surface, or the scale layer on the heated target scale accumulation surface, and back through the process fluid to the measurement ultrasonic transmitter-receiver. The transit time and the real time velocity of the ultrasound through the process fluid are used to calculate the distance between the measurement ultrasonic transmitter-receiver and the heated target scale accumulation surface or the scale layer on the heated target scale accumulation surface.

Also provided is a method for determining scale build-up on a heated surface predisposed to scale build-up wherein the transit time of an ultrasonic signal from a first or measurement ultrasonic transmitter-receiver assembly having an ultrasonic transmitter-receiver flush surface is measured. In the current method the ultrasonic transmitter-receiver assembly is capable of generating and receiving an ultrasonic signal through a process fluid. An ultrasonic signal is transmitted and reflected off of a heated target scale accumulation surface or the scale layer on the heated target scale accumulation surface back to the ultrasonic transmitter-receiver flush surface.

The transit time of a second or reference ultrasonic signal from a second or reference ultrasonic transmitter-receiver assembly having an ultrasonic transmitter-receiver flush surface is measured through the same process fluid as the ultrasonic signal from the first ultrasonic transmitter-receiver assembly. The reference ultrasonic signal is reflected off of an unheated, scaling resistant ultrasound reflecting surface that is at a known and fixed distance from the reference ultrasonic transmitter-receiver flush surface. The variation of accumulated scale on the heated surface can be determined by calculating the real time velocity of the reference ultrasonic signal and the distance the measurement ultrasonic signal traveled from the measurement ultrasonic transmitter to the heated target scale accumulation surface or to the scale layer over time.

Further provided is a device for determining scale build-up on a non-heated surface predisposed to scale build-up. The device includes a first or measurement ultrasonic transmitter-receiver assembly having an ultrasonic transmitter-receiver flush surface, wherein the transmitter-receiver assembly is capable of transmitting and receiving an ultrasonic signal through a liquid media or process fluid. The device has an ultrasonic reflector/scale collection target having a scale collection and measurement surface, wherein the transmitted ultrasonic signal is reflected off of the scale accumulation surface or the scale layer on the scale accumulation surface and back through the process fluid to the ultrasonic transmitter-receiver flush surface and the measurement ultrasonic transmitter-receiver assembly. The device has a second or reference ultrasonic transmitter-receiver assembly having an ultrasonic transmitter-receiver flush surface capable of transmitting and receiving an ultrasonic signal through the same process fluid as the ultrasonic signal from the measurement ultrasonic transmitter-receiver assembly. The device has a scaling resistant ultrasonic signal reflection target having an ultrasonic signal reflection surface, which the transmitted reference ultrasonic signal is reflected off of. The reference ultrasonic signal reflection surface is at a known and fixed distance from the reference transmitter-receiver assembly. The reference ultrasonic signal is transmitted to the scaling resistant ultrasonic reflection surface and back to the reference ultrasonic transmitter-receiver flush surface and the reference transmitter-receiver assembly.

The device includes one or more signal processors for measuring the transit time for the ultrasonic signal to travel the known distance from the reference ultrasonic transmitter-receiver assembly through the process fluid to the scaling resistant ultrasonic signal reflection surface, and back through the process fluid to the reference ultrasonic transmitter-receiver assembly. The distance and time are used to calculate the real time velocity of the reference ultrasound signal through the process fluid. The one or more signal processors also measures the transit time for the ultrasonic signal to go from the measurement ultrasonic transmitter-receiver assembly through the process fluid to an ultrasonic reflector scale collection target and back through the process fluid. The transit time and the real time velocity of the reference ultrasound signal are used to calculate the distance between the measurement ultrasonic transmitter-receiver flush surface and the scale collection and measurement surface.

Also, provided is a method of determining scale build-up on a non-heated surface predisposed to scale build-up. The method includes measuring the transit time of a first ultrasonic signal to go from a measurement ultrasonic signal transmitter-receiver assembly having an ultrasonic transmitter-receiver flush surface, through a process fluid to an ultrasonic reflector/scale collection target having a scale collection and measurement surface. The transmitted ultrasonic signal is reflected off of the scale collection and measurement surface and back to the ultrasonic signal transmitter-receiver flush surface. The transit time of a second or reference ultrasonic signal to go from a reference ultrasonic signal transmitter-receiver assembly having an ultrasonic transmitter-receiver flush surface, to an unheated scaling resistant ultrasonic signal reflection surface that is at a known and fixed distance from the ultrasonic transmitter-receiver flush surface and back is also measured. The variation of accumulated scale on the non-heated surface can be determined by calculating the real time velocity of the reference ultrasonic signal and the distance the measurement ultrasonic signal traveled from the measurement ultrasonic transmitter-receiver assembly to the scale collection and measurement surface.

### BRIEF DESCRIPTION OF THE DRAWINGS

FIG. 1, is a schematic showing the currently used concept of measuring scale build-up on a non-heated scale accumulation surface or target.

FIG. 2, is a schematic showing the new concept of measuring scale build-up on a heated scale accumulation surface or target.

FIG. 3, is a schematic showing the new concept of measuring scale build-up on a non-heated scale accumulation surface or target.

FIG. 4, illustrates the relationship between concentration and conductivity for solutions of simple binary neutral salts.

FIG. 5, illustrates the relationship between salt solution density and salt concentration.

FIG. 6, illustrates the velocity of sound in an ethanol-water mixture.

FIG. 7, illustrates the impact an uncorrected change from a base temperature at the time of calibration on ultrasonic velocity and on the indicated scale thickness on a heated scale accumulation surface.

FIG. 8, illustrates the impact an uncorrected change from a base temperature at the time of calibration has on the ultrasonic velocity and on the indicated scale thickness on unheated surfaces.

FIG. 9, illustrates scale thickness indication error on a heated scale accumulation surface due to NaCl concentration changes in the bulk water for a salt concentration range typical of system with heated surfaces.

FIG. 10, illustrates scale thickness indication error due to NaCl concentration changes in the bulk water for the range of salt concentration typically found in self-scaling systems.

### DETAILED DESCRIPTION

In industrial process liquid or fluid applications, both liquid media temperature and density affect the ultrasonic velocity through a liquid, with temperature having a greater influence on ultrasonic velocity than density. Specifically, a 1° C. increase in the temperature of water, from 25° C. to 26° C. can result in a change in the ultrasonic velocity from 1486.33 meter per second (m/s) to about 1488.78 m/s. By comparison, a change from 0 parts-per-million (ppm) to about 200 ppm NaCl can change the density of the liquid from about 0.9982 g/cm³ to about 0.9983 g/cm³, and the conductivity from 0 microSeimen per centimeter (μS/cm) to about 400 μS/cm, resulting in a change in the ultrasonic velocity from about 1486.33 m/s to about 1486.54 m/s. These velocities are based on theoretical values predicted by a mathematical model, which incorporates water temperature and salt concentration. There are a number of such models available in the literature. The calculations above use Equation 4 from “Function Dependence of Ultrasonic Speed in Water Salinity and Temperature (Y. N. Al-Nasser et al., NDT.net, June 2006, Vol. II, No. 6). There are many other models which may give slightly different values for ultrasonic velocity, but all would be suitable for the purposes of illustration.

Although these changes in the speed of sound may seem small (especially the change based on salt concentration) they are in fact significant. The reason is based on how the ultrasonic signal is used to measure the scale thickness. The initial “time of flight” measurement made when the device is in an unscaled condition, such as when using an OnGuard® 3S instrument or OnGuard® 3H , made by Solenis LLC, which can be in the range of from about 21 microseconds (μs) to about 47.8 μs, over a distance of about 16 millimeter (mm) to about 36 mm, respectively. For example, the subsequent “time of flight” measurement, made when 1 μm of scale is present, is only 0.00132 μs less than the unscaled “time of flight.” In the case of the uncompensated temperature difference, from 25° C. to 26° C., the result is an apparent increase in the scale thickness of from about 26.3 μm to about 59.1 μm for an ultrasonic transmitter-receiver to scale accumulation surface distance of 16 mm and 36 mm respectively. In the case of the uncompensated increase in fluid density of from about 0.9983 g/cm³ to 0.9984 g/cm³, the result is an apparent increase in the scale thickness of from about 1.2 μm to about 3.8 μm for an ultrasonic transmitter-receiver to scale accumulation surface distance of 16 mm and 36 mm respectively. Clearly this application requires high precision measurements, and the use of a highly accurate value for the assumed speed of sound in the liquid media.

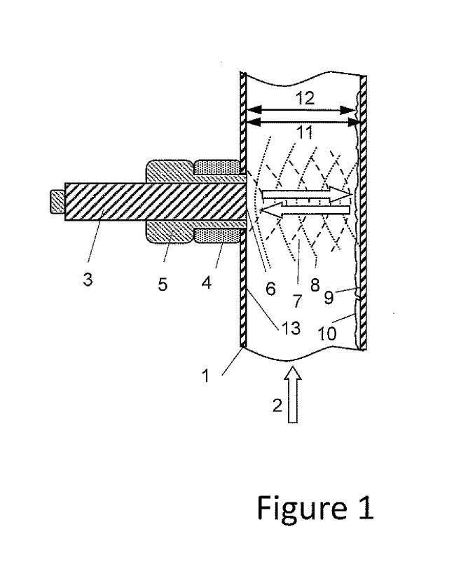

FIG. 1, illustrates the general concept for using ultrasound technology for distance measurements, prior to the present technology. A liquid media flows (2) through a pipe or flow cell (1). An ultrasonic transmitter-receiver assembly (3) is attached to the pipe or flow cell (1) by a connector or coupling means, such as a welded half-coupling (4) and an ultrasonic transmitter-receiver assembly mounting sleeve (5). The ultrasonic transmitter-receiver assembly (3) has a flush surface (6) or surface that is flush with the inside surface (13) of the pipe or flow cell (1). An ultrasonic signal (7) leaves the ultrasonic transmitter-receiver assembly (3), reflects off of the inside surface of the pipe (9) or accumulated scale (10) opposite the ultrasonic transmitter-receiver assembly (3) and is reflected back (8) to the ultrasonic transmitter-receiver assembly (3). The distance before scale build-up (11) and after scale build-up (12) is determined and the amount of scale build-up is calculated based upon the measured distances. It should be noted that the distance (11) from the ultrasonic transmitter-receiver flush surface (6) to the reflective surface (9) is pre-determined and taken when there is no scale build-up on the inside surface of the pipe or flow cell (1).

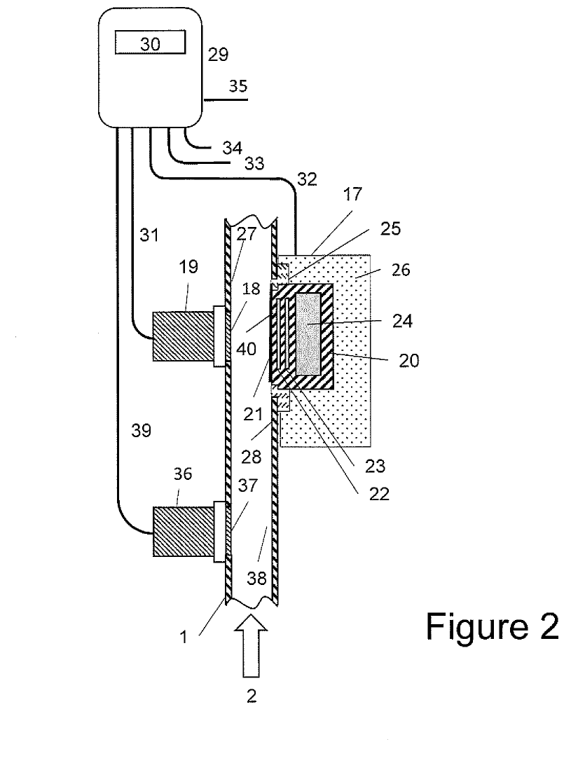

FIG. 2, shows one embodiment of the device and method of the present invention. The device and method provides for determining scale build-up on a heated surface predisposed to scale build-up. The device includes a first or measurement ultrasonic transmitter-receiver assembly (19) having an ultrasonic transmitter-receiver flush surface (18). The measurement ultrasonic transmitter-receiver assembly (19) is capable of transmitting and receiving an ultrasonic signal (7, 8), see FIG. 1, through a process fluid (2); a heated target assembly (17) having a heated target scale accumulation surface (21); wherein the transmitted ultrasonic signal (7), see FIG. 1, is reflected off of the heated target scale accumulation surface (21) or off of a scale layer or build-up (40) on the heated target scale accumulation surface (21) and the reflected ultrasonic signal (8), see FIG. 1, back to the ultrasonic transmitter-receiver flush surface (18). There is a second or reference ultrasonic transmitter-receiver assembly (36) having an ultrasonic transmitter-receiver flush surface (37), capable of transmitting and receiving an ultrasonic signal (7, 8), see FIG. 1, through the same process fluid (2) as the measurement ultrasonic signal. There is an unheated, scaling resistant ultrasonic reflecting surface (38) that is at a known and fixed distance from the ultrasonic transmitter-receiver flush surface (37) of the ultrasonic transmitter-receiver assembly (36).

In some embodiments, the device can also include one or more signal processors (29) for measuring the transit time for the ultrasonic signal to travel the known distance from the reference ultrasonic transmitter-receiver assembly (36) through a process fluid (2) to the unheated, scaling resistant ultrasound reflecting surface (38) and back through the process fluid (2) to the reference ultrasonic transmitter-receiver (36). The transit time and know distance are used to calculate the real time velocity of the ultrasonic signal through the process fluid (2). The one or more signal processors (29) also measures the transit time for the ultrasonic signal to go from the measurement ultrasonic transmitter-receiver assembly (19) through the process fluid (2) to the heated target scale accumulation surface (21), or the scale layer (40) on the heated target scale accumulation surface (21), and back through the process fluid (2) to the measurement ultrasonic transmitter-receiver assembly (19). The transit time and the real time velocity of the ultrasonic signal through the process fluid are used to calculate the distance between the measurement ultrasonic transmitter-receiver assembly (19) and the heated target scale accumulation surface (21) or the scale layer (40) on the heated target scale accumulation surface (21).

In a preferred embodiment, FIG. 2 shows a heated target (20) that is mounted to a pipe or flow cell (1) as a heated target assembly (17). The heated target (20) can be embedded in or surrounded by insulation (26) including an insulation spacer (25) that keeps the heated target from making contact with the pipe or flow cell (1). The heated target assembly (17) includes a heated target scale accumulation surface (21), a heater (24), a first temperature sensor (22) and a second temperature sensor (23), wherein the heated target scale accumulation surface (21) is mounted so that it is flush with the pipe or flow cell inside wall (28) opposite the measurement ultrasonic transmitter-receiver assembly (19).

In other preferred embodiments, calculations and determinations can be generated by one or more signal processors (29), which are connected to the measurement and reference ultrasonic transmitter-receiver assemblies (19) and (36) and the heated target assembly (17). The one or more signal processors (29) can also be connected to other types of transmitters-receivers such as, conductivity transmitters and bulk water temperature transducers (not shown).

In yet other preferred embodiments, the ultrasonic signal is in the form of a pulse and can be alternated between the reference ultrasonic transmitter-receiver assembly (36) and the measurement ultrasonic transmitter-receiver assembly (19).

The temperature, density and ion concentration of the process liquid or industrial fluid is largely dependent upon the particular application, e.g., open system, closed system, pressurized system, cooling towers, etc. In some applications the ion concentration of the process liquid can be from about 1 parts-per-million (ppm) to about 40,000 ppm and the density could be from about 0.8 g/cm³ to about 1.5 g/cm³.

The reference ultrasonic transmitter-receiver assembly (36) should be in close proximity to the measurement ultrasonic transmitter-receiver assembly (19) with the allowable separation distance dependent upon fluid velocities and the rate at which fluid conditions such as, temperature and conductivity, can change.

In other embodiments, FIG. 2, shows a display (30) can be connected to the device for monitoring and controlling the processors, for example, the measurement and reference ultrasonic transmitter-receiver assemblies (31) and (39), heated target assembly (32). Bulk water temperature transducers and other assemblies, such as conductivity transmitters and power supplies, which are not shown in the figures, can also be configured to the display and the device.

In other preferred embodiments, the surface predisposed to scale build-up can be selected from the group consisting of steel, stainless steel, copper, various compositions of brass, titanium, composites of two or more materials, and other heat conducting materials. The non-scaling reference surface can be selected from the group consisting of a DuPont Teflon® non-stick surface, a highly polished surface, and an ultra-hydrophobic surface. The non-scaling reference surface can also be composed of or treated with an anti-scaling composition such as a DuPont Teflon®, a nano-particle coating, an antifouling paint, a silicone (polymerized siloxanes), polyethylene, or similar materials or coatings known to those skilled in the art.

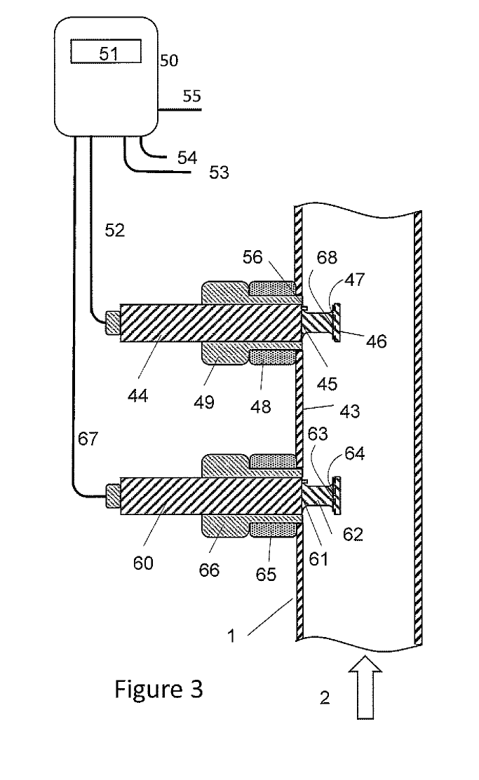

The present application also provides for a device and method for determining scale build-up on a non-heated surface predisposed to scale build-up. Referring to FIG. 3, the device includes a first or measurement ultrasonic transmitter-receiver assembly (44) having an ultrasonic transmitter-receiver flush surface (45), that is capable of transmitting and receiving an ultrasonic signal through a liquid media or process fluid (2). The ultrasonic transmitter-receiver assembly (44) is attached to a pipe or flow cell (1) by a connector or coupling means, such as a welded half-coupling (65) and an ultrasonic transmitter-receiver assembly mounting sleeve (66). In addition, the device has an ultrasonic reflector/scale collection target (46) having a scale accumulation surface (47), wherein the transmitted ultrasonic signal is reflected off of the scale accumulation surface (47) or off of a scale layer or build-up (68) and back through the process fluid to the measurement ultrasonic transmitter-receiver flush surface (45) and the measurement ultrasonic transmitter-receiver assembly (44). The device has a second or reference ultrasonic transmitter-receiver assembly (60) having an ultrasonic transmitter-receiver flush surface (61), wherein the reference ultrasonic transmitter-receiver assembly (60) is capable of transmitting and receiving an ultrasonic signal through the same process fluid as the ultrasonic signal from the measurement ultrasonic transmitter-receiver assembly (44). The device has a scaling resistant ultrasonic signal reflection target (62) and a scaling resistant ultrasonic reflection surface (63), that the transmitted ultrasonic signal is reflected off of. The ultrasonic signal reflecting surface (63) is at a known and fixed distance from the reference ultrasonic transmitter-receiver assembly (60). The reference ultrasonic signal is transmitted to the scaling resistant ultrasonic signal reflection surface (63) and back to the ultrasonic transmitter-receiver flush surface (61) and the reference transmitter-receiver assembly (60).

In a preferred embodiment, there can be a scaling resistant reflection surface treatment on the ultrasonic reflection surface (64).

The device includes one or more signal processors (50) that can measure the transit time for the ultrasonic signal to travel the known distance from the reference ultrasonic transmitter-receiver assembly (60) and ultrasonic transmitter-receiver flush surface (61) through the process fluid (2) to the scaling resistant ultrasonic signal reflection target (62), and back through the process fluid (2) to the reference ultrasonic transmitter-receiver assembly (60) and ultrasonic transmitter-receiver flush surface (61), which is used along with the known separation distance, to calculate the real time velocity of the reference ultrasound signal through the process fluid (2); and also measures the transit time for the ultrasonic signal to go from the measurement ultrasonic transmitter-receiver assembly (44) through the process fluid (2) to an ultrasonic reflector/scale collection target (46), having a scale accumulation surface (47) or scale build up (48) on the scale accumulation surface (47), and back through the process fluid (2) to the measurement ultrasonic transmitter-receiver flush surface (45), wherein the transit time and the real time velocity of the reference ultrasound signal are used to calculate the distance between the measurement ultrasonic transmitter-receiver flush surface (45) and the scale accumulation surface (47) or off of the scale build-up (48). The changes in the calculated distance between the measurement ultrasonic transmitter-receiver assembly (44) and the ultrasonic reflector scale accumulation surface (47) or scale layer (68) over time are used as an indicator of accumulated scale thickness on the non-heated surface.

In some preferred embodiments, the process liquid or fluid is subject to temperature, ion concentration and/or density variations causing variation of the velocity of the ultrasound in the liquid media. To measure this the device can further comprise one or more measuring devices for measuring variations in temperature, ion concentration or composition, non-ionic dissolved or suspended component concentration or composition, and/or density variations of the industrial fluid.

In other embodiments, FIG. 3, shows a display (51) on signal processor (50), can be connected to the device for monitoring and controlling the processors, for example, the measurement and reference ultrasonic transmitter-receiver assemblies (44) and (60), and bulk water temperature transducer (56) via cables (52), (67) and (54), respectively. Other such assemblies, such as conductivity transmitters and power supplies, which are not shown in the figures, can also be configured to the display and device.

In some preferred embodiments, there is a calibration that zeros the scale thickness indication at the start of a test period. This can be done when the scale accumulation surface is free of scale, and the process liquid salt concentration and temperature are at or very close to the anticipated concentration and temperature for long term operation. If the scale accumulation surface has accumulated some scale at the time the calibration routine is performed, the future scale accumulation can be indicated as the scale thickness. However, it is typical for bulk water temperature, density, conductivity, and composition to change during normal operation.

In some aspects, the extent of the error due to changes in bulk liquid temperature and salt concentration can be calculated using the known relationship between the concentration of a specific salt and conductivity. NaCl can be used for all the calculations because data for pure water with only NaCl in it is readily available in the literature, while data for mixtures of Na⁺, Ca⁺², Mg⁺², Cl⁻¹, HCO₃⁻¹, CO₃⁻², SO₄⁻², and other ionic species that are commonly present in different proportions at each field location are generally not available in the literature. The NaCl model system is more than adequate to illustrate the issues presented here.

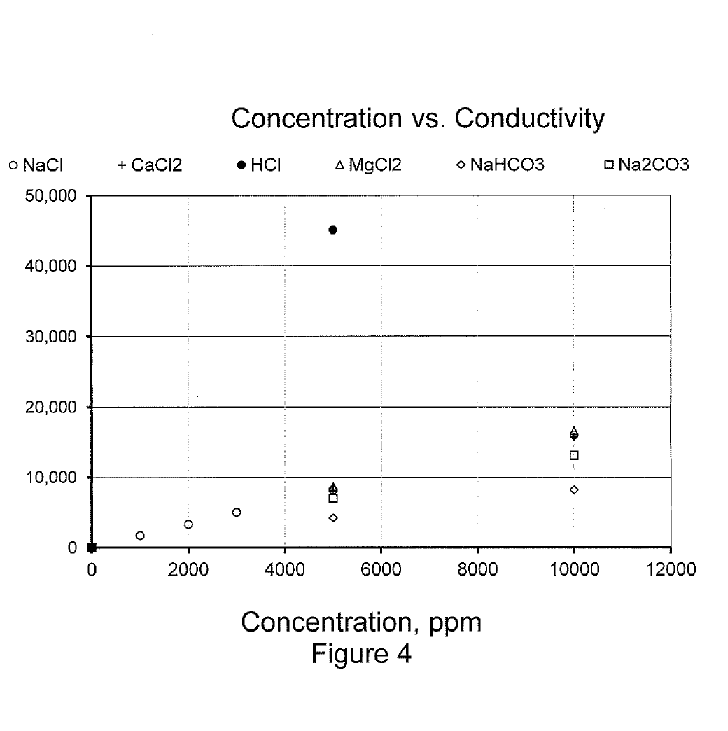

FIG. 4, illustrates that while a near linear general relationship between concentration and conductivity can be shown for solutions of simple binary neutral salts, some exceptions can also be seen (see Table 1). For example, NaHCO₃ deviates significantly from the general relationship, possibly because the bicarbonate ion has a complicated ionization path that can involve absorption from or release to the atmosphere of gaseous CO₂. NaHCO₃ in highly variable amounts is a common component of cooling towers or industrial process liquids or fluids. Likewise, acids such as HCl produce much higher conductivity at a given parts-per-million concentration (92,900 μS/cm at 10,000 ppm, far off the scale of the chart of FIG. 4), possibly because they ionize the solvent (water).

TABLE 1
Conductivity (μS/cm) vs. solute concentration
(ppm) (Data Source: CRC Handbook 56th Ed, 1975)

| ppm | NaCl | CaCl₂ | HCl | MgCl₂ | NaHCO₃ | Na₂CO₃ |
|---|---|---|---|---|---|---|
| 0 | 0 | 0 | 0 | 0 | 0 | 0 |
| 1000 | 1700 | | | | | |
| 2000 | 3300 | | | | | |
| 3000 | 5000 | | | | | |
| 5000 | 8200 | 8100 | 45100 | 8600 | 4200 | 7000 |
| 10000 | 16000 | 15700 | 92900 | 16600 | 8200 | 13100 |

It is well known to those skilled in the art that ultrasonic velocity in both fluids and solids can be described by the theoretical relationship V=(k/ [symbol] )^{0.5} where V is the velocity, k is the elastic property of the material (bulk modulus for water) and [symbol] is the material density.

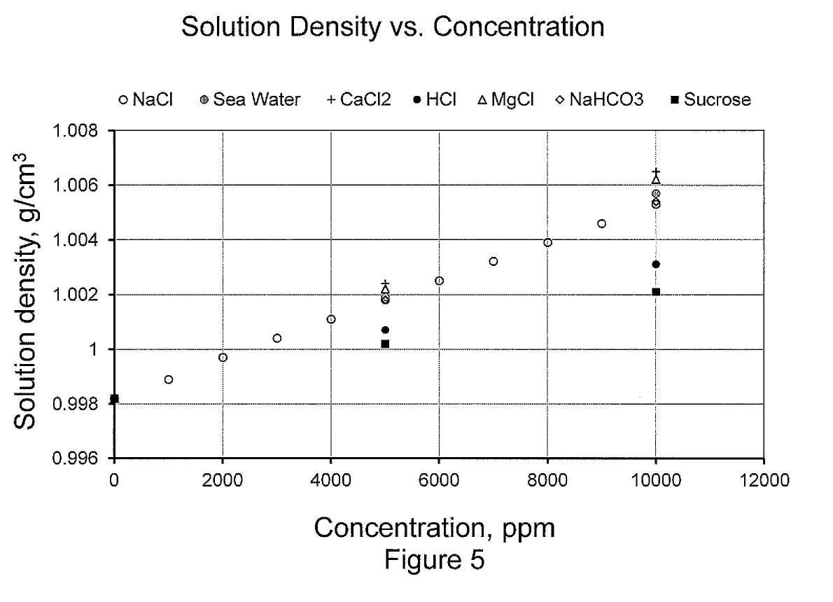

The relationship between density and concentration for various salts were also explored. Results are provided in Table 2 and FIG. 5, which shows that density increases approximately linearly with salt concentration, but the slope of the regression model is different for each salt.

TABLE 2
Concentration vs. Density for various solutes; values at 20°
C.; density as g/cm³ (Data source: CRC Handbook, 56th Ed., 1975)

| ppm | NaCl | Sea Water | CaCl₂ | HCl | MgCl | NaHCO₃ | Sucrose |
|---|---|---|---|---|---|---|---|
| 0 | 0.9982 | 0.9982 | 0.9982 | 0.9982 | 0.9982 | 0.9982 | 0.9982 |
| 1000 | 0.9989 | | | | | | |
| 2000 | 0.9997 | | | | | | |
| 3000 | 1.0004 | | | | | | |
| 4000 | 1.0011 | | | | | | |
| 5000 | 1.0018 | 1.0019 | 1.0024 | 1.0007 | 1.0022 | 1.0018 | 1.0002 |
| 6000 | 1.0025 | | | | | | |
| 7000 | 1.0032 | | | | | | |
| 8000 | 1.0039 | | | | | | |
| 9000 | 1.0046 | | | | | | |
| 10000 | 1.0053 | 1.0057 | 1.0065 | 1.0031 | 1.0062 | 1.0054 | 1.0021 |

Notice in particular that the linear relationship between concentration and density (albeit with different slopes for the various solutes) is generally true for ionic and non-ionic solutes. For example, sucrose is highly soluble but it is covalently bonded, so it does not ionize except when the sugar molecule is oxidized or reduced by other components in the solvent. It will contribute to liquid density but less so or not at all to conductivity, depending on the pH and other reactive species present. Even if the conductivity signal were used to correct the ultrasonic velocity, variables such as a contaminant, changing concentrations of components such as sucrose or oil, or a non-ionizing miscible liquid such as ethanol would likely go unnoticed since there would be a change in water density (and the ultrasonic velocity) but little or no change in conductivity. On line density meters of the required accuracy are not readily available and the precise density of industrial cooling tower sump water or other waters that are subject to scaling has heretofore not been recognized as a significant parameter.

While water density can be calculated at various temperatures via regression models, the ultrasonic velocity vs. density relationship described above cannot be used for temperature corrections. We observe that the velocity of ultrasound in fluids (liquids and gasses) actually increases with increasing temperature. Analysis of the previously mentioned theoretical relationship V=(k/ [symbol] )^{0.5} suggests the opposite, if we assume the elastic properties (k) are unaffected by temperature. The general explanation for why ultrasonic velocity increases with increasing temperature in liquids (and gasses) is because sound waves propagate by displacing the media molecules. As the temperature increases, the molecules move faster, so sound waves propagate faster.

Continuing with the discussion of the molecular displacement model for propagation of sound waves in fluids (liquids in this case), it has also been shown that energy is transferred from one molecule to the adjacent molecule via media displacement. At a fixed temperature, less energy is required to transfer displacement between smaller molecules than between larger molecules. This is why at equal densities, solutions of larger molecules tend to transmit sound waves slower than solutions of smaller molecules. However, the ultrasonic response is not as regular as might otherwise be expected. SensoTech (Magdeburg- Barleben, Germany) markets an ultrasonic concentration meter (trade name is LiquiSonic®) for determining the concentration of aqueous and non-aqueous solutions of various solutes.

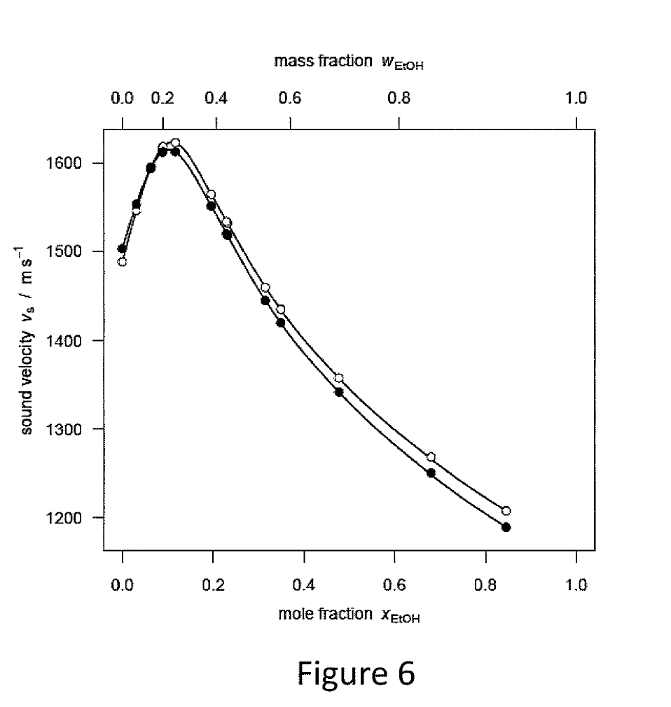

The velocity of sound in an ethanol-water mixture is irregular and temperature dependent. For example, FIG. 6 shows the sound velocity of ethanol-water mixtures at temperatures of 22.2° C. and at 27.6° C. The plot uses at the bottom of the graph the mole fraction of ethanol and the weight fraction of ethanol as a top scale. Both isotherms show a pronounced concentration dependence with slightly different maximum velocities. It can also be seen that there is a reversed temperature effect at high and low concentration and the crossing of the isotherms.

Since ethanol is non-ionic, solution conductivity is not altered by the percentage of ethanol. While the composition of the water-ethanol mix is easily determined by the solution density, solution density is not easily measured with the necessary precision in an on-line device, and even then the model is complex and temperature dependent. If there is potential for multiple solutes of unknown concentrations, the impracticality of estimating the velocity of ultrasound via a predictive model is seen.

Regarding density measurements, even if a precise enough determination of liquid density could be obtained, a density measurement is not sufficient to correctly predict the ultrasonic velocity, except in pure systems of known components across a limited range of concentrations. The reasons for this irregular ultrasonic velocity behavior are currently unknown.

A model for density (specific to NaCl in water) uses the previously mentioned combined temperature and concentration relationships of Al-Nassar (NDT.net, June 2006, Vol. 11 No. 6) to predict ultrasonic velocity in the practical conductivity range and temperature range for industrial cooling towers and for self-scaling aqueous process liquids. Additional calculations are made to determine the “time of flight” for an assumed 1-way distance of 16 millimeters for a currently available device which accumulates scale on a heated surfaces in cooling towers, and 36 millimeters for a currently available device which accumulates scale on an unheated surfaces in self-scaling environments, and the consequent impact of changing the bulk water temperature or conductivity after calibration.

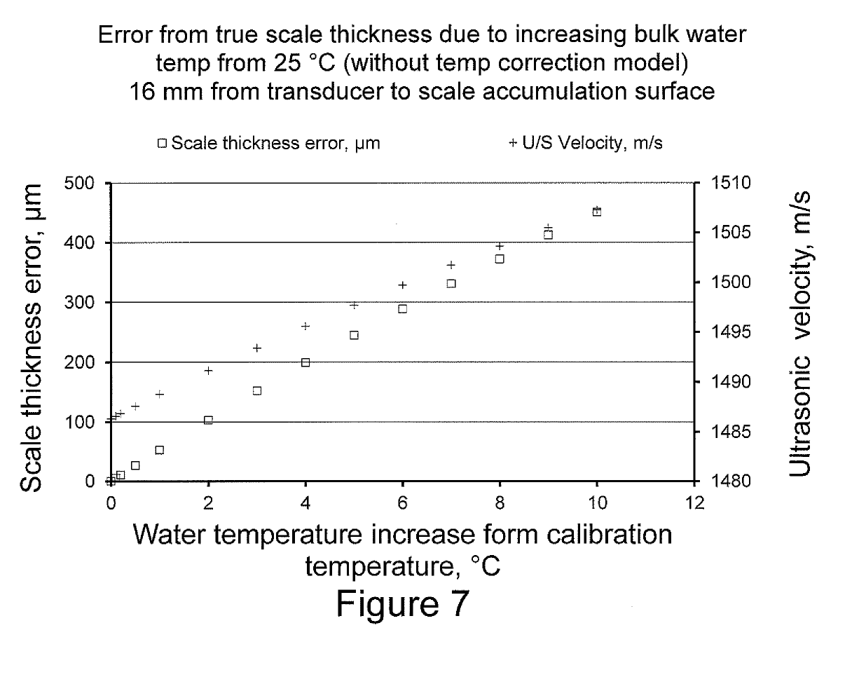

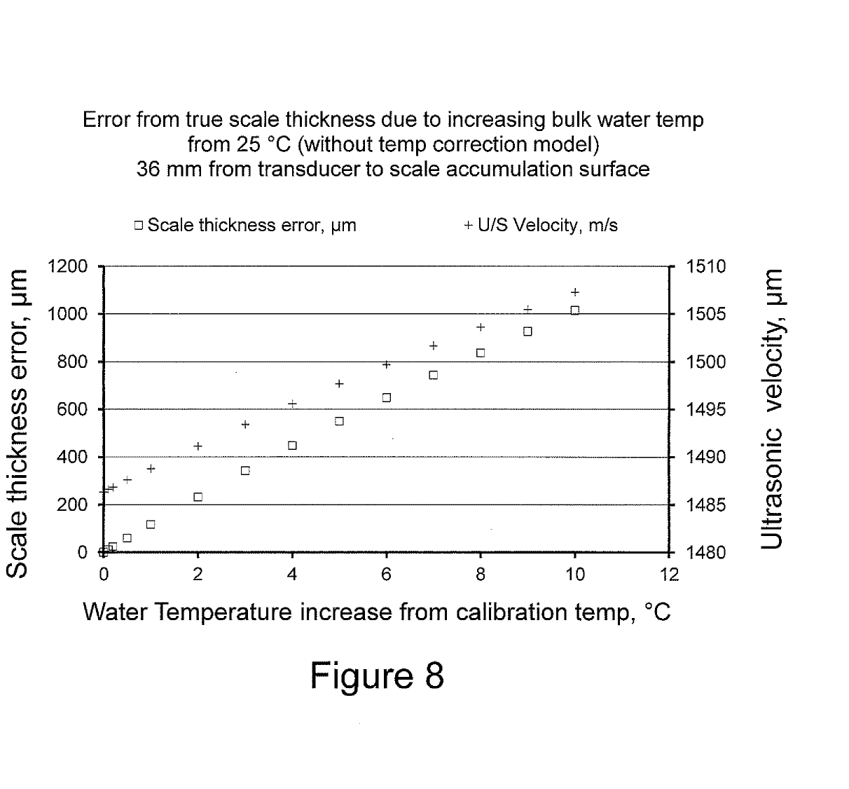

The calculations described above can be used to produce graphs (See Table 3 and FIGS. 7 and 8) of the impact an uncorrected change from a base temperature at the time of calibration has on the ultrasonic velocity and on the indicated scale thickness, even though no actual scale is present. It is clear from FIGS. 7 and 8 that the scale thickness indication error is large relative to the range of scale thickness likely to be encountered during operation of an ultrasonic measuring device, for both a heated and an unheated scale accumulation case (FIG. 7, illustrates a distance of 16 mm between the ultrasound transmitter-receiver flush surface and the scale accumulation surface while FIG. 8, is at a distance of 36 mm between the ultrasound transmitter-receiver flush surface and the scale accumulation surface), even for a modest 2° C. increase in the bulk water temperature. In fact, results are so erroneous without a temperature correction that the ultrasonic measurements are nearly useless.

TABLE 3
Calculated ultrasonic velocity for pure water as
temperature increases from 25° C., and the calculated scale
thickness error for a 1 way distance of 16 mm (FIG. 7) and 36 mm
(FIG. 8)

| | | FIG. 7 | |
|---|---|---|---|
| | FIGS. 7 & 8 | Scale | FIG. 8 |
| Temperature | U/S Velocity, | thickness | Scale thickness |
| increase, C. | m/s | error, μm | error, μm |
| 0 | 1486.33 | 0.00 | 0.00 |
| 0.1 | 1486.58 | 5.35 | 12.04 |
| 0.2 | 1486.83 | 10.68 | 24.03 |
| 0.5 | 1487.57 | 26.55 | 59.73 |
| 1 | 1488.78 | 52.58 | 118.30 |
| 2 | 1491.13 | 103.17 | 232.14 |
| 3 | 1493.39 | 151.93 | 341.84 |
| 4 | 1495.57 | 198.97 | 447.69 |
| 5 | 1497.69 | 244.42 | 549.95 |
| 6 | 1499.73 | 288.38 | 648.85 |
| 7 | 1501.70 | 330.94 | 744.62 |
| 8 | 1503.62 | 372.19 | 837.43 |
| 9 | 1505.48 | 412.21 | 927.48 |
| 10 | 1507.28 | 451.07 | 1014.92 |

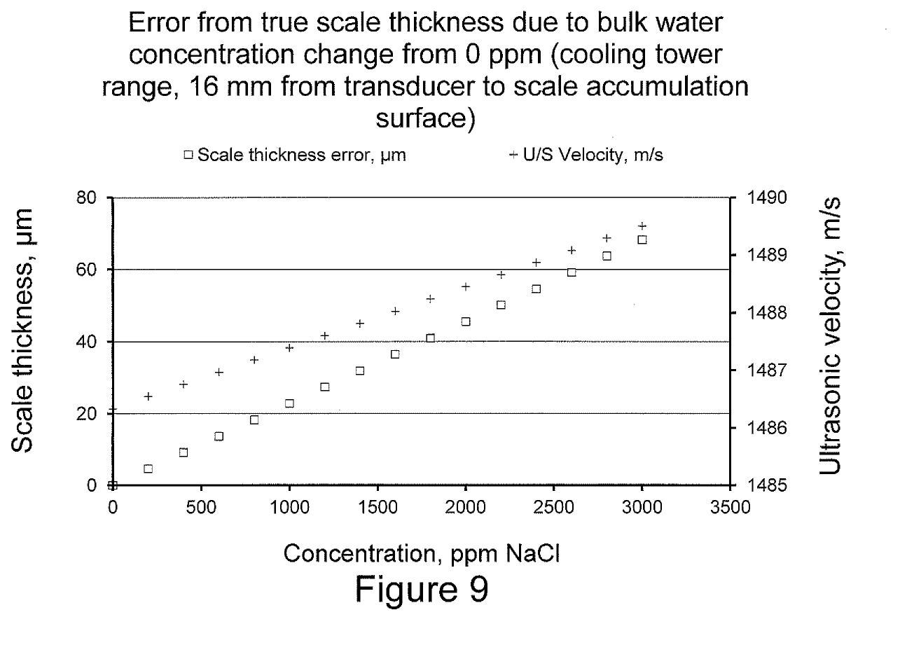

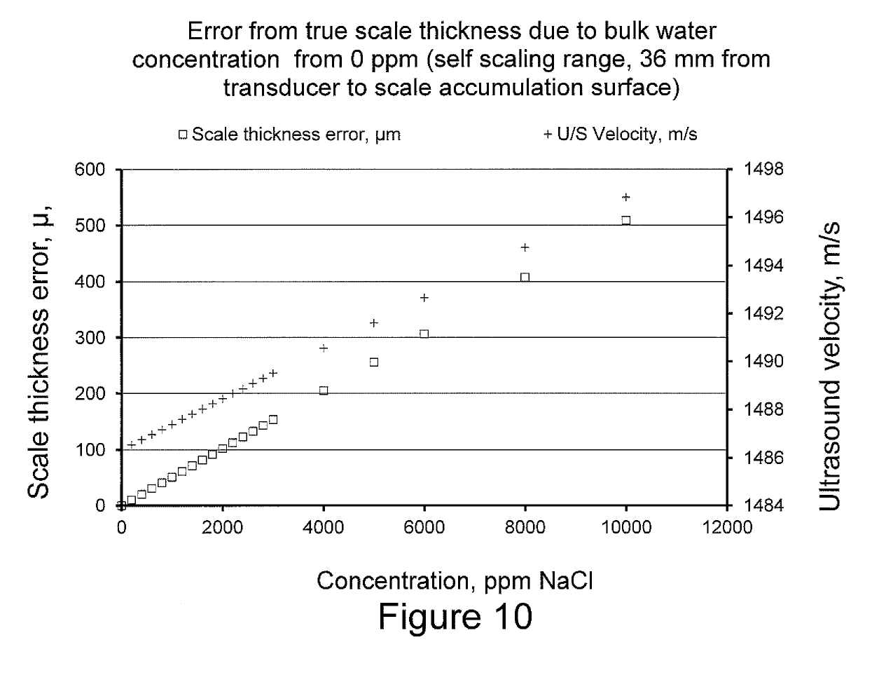

The same (Al-Nassar) models are used to produce a graphic illustrating the effect of changes in the concentration of NaCl on reported scale error; see FIGS. 9 and 10 (Table 4) below. For reference, conductivities in the range of 3000 μS/cm, corresponding to about 1572 ppm of NaCl, are common in industrial cooling waters. FIG. 9, shows that this concentration, whether on heated or non-heated surfaces could result in a scale thickness error of 17.9 μm if the device was calibrated at 0 μS/cm, and then the conductivity increased to 3000 μS/cm. It is clear that the impact of salt concentration or density on ultrasonic velocity and on the indicated scale thickness indication is significant, even if much smaller than the effect of an uncorrected temperature change.

As can be seen in Table 4, concentration of salts can easily exceed 10,000 ppm (1%) in self scaling systems.

TABLE 4
Calculated ultrasonic velocity for pure water as salt
concentration increases, and the calculated scale thickness error
for a 1 way distance of 16 mm (FIG. 9) and 36 mm (FIG. 10).

| | | FIG. 9 | FIG. 10 |
|---|---|---|---|
| | FIGS. 9 & 10 | Scale | Scale |
| Concentration, | U/S Velocity, | thickness | thickness |
| ppm NaCl | m/s | error, μm | error, μm |
| 0 | 1486.33 | 0 | 0.00 |
| 200 | 1486.54 | 4.56 | 10.26 |
| 400 | 1486.76 | 9.12 | 20.51 |
| 600 | 1486.97 | 13.67 | 30.76 |
| 800 | 1487.18 | 18.23 | 41.01 |
| 1000 | 1487.39 | 22.78 | 51.25 |
| 1200 | 1487.60 | 27.33 | 61.49 |
| 1400 | 1487.81 | 31.88 | 71.73 |
| 1600 | 1488.03 | 36.43 | 81.97 |
| 1800 | 1488.24 | 40.98 | 92.20 |
| 2000 | 1488.45 | 45.52 | 102.42 |
| 2200 | 1488.66 | 50.07 | 112.67 |
| 2400 | 1488.87 | 54.61 | 122.91 |
| 2600 | 1489.08 | 59.15 | 133.15 |
| 2800 | 1489.29 | 63.69 | 143.39 |
| 3000 | 1489.50 | 68.23 | 153.51 |
| 4000 | 1490.55 | | 204.52 |
| 5000 | 1491.61 | | 255.44 |
| 6000 | 1492.66 | | 306.28 |
| 8000 | 1494.75 | | 407.71 |
| 10000 | 1496.84 | | 508.80 |

These changes in temperature and concentration are relevant examples because even though it is preferred to calibrate the device at the salt concentration, bulk process liquid temperature and velocity, and even the heated target power setting it can be anticipated to operate at, sometimes it must be calibrated while operating on non-typical water. In addition, bulk process liquid temperature may vary over the diurnal cycle, and the annual/seasonal cycle, with changing industrial process conditions, and so on. Concentration can be controlled to a conductivity set point, but sometimes it goes out of control, perhaps due to a stuck blowdown or makeup valve, leakage of product into the cooling or process liquid, or simply an intentional conductivity set point change. In some aspects, salt concentration most likely is not controlled and may not even be measured.

A commercial scale measurement device for self-scaling waters is commonly used in waters with conductivities at up to 34,000 μS or about 1.7% by wt. NaCl.

The impact of pressure on ultrasonic velocity is also reported in the literature. Generally speaking, most of the information in the literature has to do with ultrasonic velocity through sea water at varying depths. This data is difficult to interpret because water typically gets much colder and the salt content can vary as the depth increases, in addition to the pressure effect. Yet another complication relates to the mechanical construction details of the ultrasonic transmitter-receiver assembly. Its diaphragm tends to deflect away from the pressure. In one experimental setting, it was found that as the pressure on the ultrasonic transmitter-receiver assembly increased one atmosphere, the indicated scale thickness decreased by about 10 μm, even though there was no actual change in scale thickness. Since the extent of diaphragm deflection is specific to the ultrasonic transmitter-receiver assembly design, a theoretical model is not relevant. Variations in indicated scale thickness due to pressure changes are probably best addressed by operating scale measurement devices at constant pressure, or by an empirical model.

There is always the potential for product contamination of the cooling water in cooling tower systems, due to a leak or rupture of a gasket between the product and the cooling water. This is another potential source of inaccuracy of the measured scale thickness. For example, cooling water could become contaminated by oil or other petroleum products in an oil refinery, or by sugar in a sugar refinery. If the infused solute molecules are ionically bonded (e.g. brine, strong acids, etc.), then a large change in the conductivity may be observed. However, if the infused solute molecules are covalently bonded (e.g., oil or sugar), little or no change in the conductivity would be observed. A significant infusion of ionizing or non-ionizing material into the cooling water would produce a significant change in the cooling water density and in the ultrasonic velocity, resulting in an erroneous indicated scale thickness.

In addition to potential infusion of dissolved ionic or non-ionic solutes, leakage of particulate or suspended solids may also impact the ultrasonic velocity or attenuate its signal. Since many process tanks are open to the atmosphere, airborne partially soluble fly ash, pollen, dust, leaves, insects, or internally generated precipitated crystals, and other particulate could accumulate in the process or cooling liquid.

The casual observer would be unlikely to immediately realize the specific cause of an indicated change in the scale thickness indication, and would likely assume the scale thickness indication reflected a bona fide change in the scale thickness. This may result in an unnecessary and costly or even a counterproductive change in the cooling water scale control treatment program.

In some aspects of the current method, a second ultrasonic transmitter-receiver assembly is placed immediately upstream or downstream of the first or measurement ultrasonic transmitter-receiver and reflected off a fixed, unheated, non-scaling reference target used to generate a reference signal. The non-scaling reflective surface is set at a known and fixed distance so its “time-of-flight” is directly proportional to the velocity of the ultrasonic signal in the liquid media, although both the measured “time-of-flight” and consequently the calculated real-time ultrasonic velocity changes as the liquid media temperature, concentration, or composition changes. By alternating the signal pulse between the reference ultrasonic transmitter-receiver assembly and the measurement ultrasonic transmitter-receiver assembly, the actual ultrasonic velocity through the liquid media can be calculated to a very high degree of accuracy for every scale thickness measurement. This allows the measurement signal (the signal aimed at the heated or non-heated scale accumulation surface depending on the application) to be corrected for the actual or current ultrasonic velocity at the time of the measurement, thus providing a more accurate value for the ultrasonic velocity than one based on just a temperature correction or a temperature and conductivity correction.

This can be done without measuring process liquid temperature, density, concentration, conductivity, composition, or any other liquid parameter. All that is needed to produce an accurate ultrasonic scale thickness measurement is an accurate ultrasonic velocity estimate, derived from the reference signal, reflected off a non-scaling surface at a known and fixed distance from the signal source.

In some preferred embodiments of the current method, the reference ultrasonic transmitter-receiver assembly can be added or included either in the same probe as the scale measurement ultrasonic transmitter-receiver, or in a separate probe, and must be aimed at a non-scaling surface. Examples of non-scaling surfaces include DuPont Teflon® non-stick surfaces, certain nano-particle coated surfaces, some ultra-hydrophobic surface treatments, silicone (polymerized siloxanes), and potentially many other polymeric coated surfaces. Ideally the surface would be a thin coating, so as not to excessively attenuate the returning ultrasonic signal. When applied to a reference ultrasonic transmitter-receiver assembly aimed at a scale resistance surface, a well-polished or micro-finished metal surface or even a highly polished ceramic surface without a special coating may be sufficient for the reference ultrasonic transmitter-receiver reflective target in some cases.

Another reason for using a thin coating rather than a solid polymeric or Teflon® block as an ultrasonic signal reflector is the tendency of polymers to have a significant coefficient of thermal expansion (linear or volumetric) relative to metals, which would alter the exact distance between the ultrasonic transmitter-receiver flush surface and the reflective target surface as the process liquid temperature changes. In reality the coefficient of thermal expansion of Teflon in particular is not constant across the range of interest. According to a Kirby (Journal of Research of the National Bureau of Standards 37(2), August 1958), Teflon has a very large spike in its coefficient of thermal expansion at 20° C. and a smaller one at 30° C., a temperature range often encountered in the liquid process streams. Teflon is also not very resistant to deflection under load, and it creeps under the load of mechanical fasteners. These characteristics make the use of a Teflon block less desirable. Silicones and many other polymeric materials have similar shortcomings that discourage consideration of a solid block of polymeric material as a non-scaling target to reflect the signal.

It makes more sense to use a Teflon coated metal surface. Teflon is highly resistant to adhesion of scale, biofilm, or pretty much anything else, and has been applied as a thin layer on metals like aluminum and stainless steel for decades. The typical layer thickness is about 25 μm to about 75 μm, which is too thin to significantly attenuate the ultrasonic signal. Such Teflon coatings have been used for many years as non-stick surfaces for cookware, where they are routinely subjected to huge temperature swings, and some abrasion. Since the coating layer is very thin, the coefficient of thermal expansion is not important (actual thickness change would be insignificant) and since it is chemically bonded to the metal surface, creep and bending stiffness are not relevant. As a replaceable part, the actual wear life is of interest but anything over a year or so would be acceptable in an industrial environment. Teflon is also highly resistant to a very wide range of process and cleaning chemicals, such that failure of the Teflon coated surface by chemical attack is highly unlikely.

In some aspects, the reference ultrasonic transmitter-receiver assembly can be added either in the same flow cell as the measurement ultrasonic transmitter-receiver assembly, or in a separate cell in series with the current cell aimed at the wall of the flow cell.

Although bulk water temperature is an important parameter and will almost certainly be measured and recorded, it would no longer be necessary to measure the bulk water temperature to calculate an accurate ultrasonic velocity. While conductivity is an important indicator of cycles of concentration or salinity and is generally also measured, it would not be needed for that purpose with the present invention. Use of a reference signal to measure the ultrasonic velocity can provide a more accurate indication of the real time ultrasonic velocity than the use of a model that incorporates a measured water temperature or conductivity value or both.

In yet other embodiments of the method, the reference ultrasonic transmitter-receiver can detect a significant infusion of solute or entry of contamination into the process liquid by indicating a significant change in the ultrasonic velocity, beyond what might have otherwise been expected in normal operation from routine temperature and dissolved material content variability. During normal operation, the measured ultrasonic velocity should change very little, and any changes can be clearly explained by corresponding changes in the process liquid temperature, conductivity, concentration, etc. A significant change in the measured ultrasonic velocity (for example, a major change in the ultrasonic velocity, or an attenuation of the reference signal), absent expectation based on conductivity and/or temperature changes, is a clear signal to look for signs of product infusion into the cooling water, unexpected biofilm growth, or an influx of suspended solids in the water. Meanwhile, the measured ultrasonic velocity continues to provide a highly accurate estimation of the ultrasonic velocity under the current fluid conditions, such that the accuracy of the indicated ultrasonic scale thickness measurement is maintained, even as the scale monitoring device operates under these abnormal conditions.

Scale can accumulate at rates of less than 1 micrometer per month. The corrections provided by the reference ultrasonic signal are less critical when the rate of scale accumulation is very high, because the indicated scale thickness will show rapid increases regardless of the absolute accuracy of the thickness values under such conditions. The real value of the reference signal is in cases where scale accumulation rate is low, and every micrometer of scale thickness indicated is scrutinized, or used to initiate a control action. This will likely be the case for many field applications, where the objective of monitoring scale thickness is to avoid rapid or substantial scale thickness accumulation while minimizing scale control costs.

Each reference cited in the present application above, including books, patents, published applications, journal articles and other publications, is incorporated herein by reference in its entirety.

We claim:

1. A device for determining scale build-up on a non-heated surface predisposed to scale build-up comprising:
a first or measurement ultrasonic transmitter-receiver assembly having an ultrasonic transmitter-receiver flush surface, wherein the ultrasonic transmitter-receiver assembly is capable of transmitting and receiving an ultrasonic signal through an industrial fluid; and an ultrasonic reflector/scale collection target having a scale accumulation surface, wherein the transmitted ultrasonic signal is reflected off of the scale accumulation surface or the scale on the target scale accumulation surface and back through the industrial fluid to the measurement ultrasonic transmitter-receiver flush surface of the measurement ultrasonic transmitter-receiver assembly;
a second or reference ultrasonic transmitter-receiver assembly having an ultrasonic transmitter-receiver flush surface, wherein the ultrasonic transmitter-receiver assembly is capable of transmitting and receiving an ultrasonic signal through an industrial fluid; and an ultrasonic signal reflection target having a scaling resistant ultrasound reflection surface, wherein the transmitted ultrasonic signal is reflected off of the scaling resistant ultrasound reflection surface, which is at a known and fixed distance from the reference transmitter-receiver assembly, back to the ultrasonic transmitter-receiver flush surface of the reference transmitter-receiver assembly;
one or more signal processors for measuring the transit time for the ultrasonic signal to travel the known distance from the reference ultrasonic transmitter-receiver assembly having an ultrasonic transmitter-receiver flush surface through the industrial fluid to the scaling resistant ultrasonic signal reflection target, and back through the industrial fluid to the reference ultrasonic transmitter-receiver assembly having an ultrasonic transmitter-receiver flush surface, which is used along with the known separation distance to calculate the real time velocity of the reference ultrasound signal through the industrial fluid and also measures the transit time for the ultrasonic signal to go from the measurement ultrasonic transmitter-receiver assembly through the industrial fluid to an ultrasonic reflector/scale collection target, having a scale accumulation surface, and back through the industrial fluid to the measurement ultrasonic transmitter-receiver flush surface, wherein the transit time and the real time velocity of the reference ultrasound signal are used to calculate the distance between the measurement ultrasonic transmitter-receiver flush surface and the heated target scale accumulation surface or the scale on the heated target scale accumulation surface.

2. The device according to claim 1, wherein the device further comprises one or more measuring devices for measuring variations in temperature, ion concentration or composition, non-ionic dissolved or suspended component concentration or composition, and/or density variations of the industrial fluid.

3. The device according to claim 1, wherein the ultrasonic signal is in the form of a pulse and can be alternated between the reference ultrasonic transmitter-receiver assembly and the measurement ultrasonic transmitter-receiver assembly.

4. The device according to claim 1, wherein the ion concentration of the industrial fluid is from about 1 ppm to about 40,000 ppm.

5. The device according to claim 1, wherein the density of the industrial fluid liquid is from about 0.8 g/cm to about 1.5 g/cm³.

6. The device of claim 1, wherein the surface predisposed to scale build-up is selected from the group consisting of steel, stainless steel, copper, various compositions of brass, titanium, composites of two or more materials, and other heat conducting materials or materials predisposed to scale accumulation.

7. The device of claim 1, wherein the non-scaling reference surface is selected from the group consisting of a DuPont Teflon® non-stick surface, a nano-particle coated surface, and a highly polished surface

8. The device of claim 7, wherein the non-scaling reference surface has a coating selected from the group consisting of a polymeric coating, a silicone coating and an ultra-hydrophobic coating.

9. The device according to claim 1, wherein the reference ultrasonic transmitter-receiver is located in the same flow cell as the measurement ultrasonic transmitter-receiver, can be in a separate cell in series with the current cell or in a nearby location within the industrial fluid flow stream.

10. A method of determining scale build-up on a non-heated surface predisposed to scale build-up comprising:
measuring the transit time of a first ultrasonic signal to go from a measurement ultrasonic signal transmitter-receiver assembly having an ultrasonic transmitter-receiver flush surface, through an industrial fluid to an ultrasonic reflector/scale collection target having a scale collection and measurement surface, wherein the transmitted ultrasonic signal is reflected off of the scale accumulation surface or the scale layer on the scale accumulation surface and back to the ultrasonic signal transmitter-receiver flush surface of the measurement ultrasonic signal transmitter-receiver assembly;
measuring the transit time of a second or reference ultrasonic signal to go from a reference ultrasonic signal transmitter-receiver assembly having an ultrasonic transmitter-receiver flush surface, to an unheated scaling resistant ultrasonic signal reflection target, which is at a known and fixed distance from the ultrasonic transmitter-receiver flush surface of the reference ultrasonic signal transmitter-receiver assembly; and
determining the variation of accumulated scale on the non-heated surface by calculating the real time velocity of the reference ultrasonic signal and the distance the measurement ultrasonic signal traveled from the measurement ultrasonic transmitter-receiver assembly and the scale accumulation surface or the scale layer on the scale accumulation surface.

11. The method of claim 10, wherein one or more signal processors are used for measuring and recording the transit time for the ultrasonic signal to go from the reference ultrasonic transmitter-receiver assembly having an ultrasonic transmitter-receiver flush surface through the industrial fluid to the unheated, scaling resistant ultrasound reflecting surface and back through the industrial fluid to the reference ultrasonic transmitter-receiver wherein the transit time and the known distance between the ultrasonic transmitter-receiver flush surface and the unheated, scaling resistant ultrasonic transmitter-receiver flush surface are used to calculate the real time velocity of the reference ultrasonic signal.

12. The method of claim 10, wherein the real time velocity of the reference ultrasonic signal is used in the calculation of the distance traveled by the measurement ultrasonic signal from the measurement ultrasonic transmitter-receiver assembly to the scale accumulation surface or to the scale layer on the scale accumulation surface.

13. The method of claim 10, wherein one or more signal processors are used for measuring and recording the transit time for the ultrasonic signal to go from the reference ultrasonic transmitter-receiver assembly through the industrial fluid to the unheated, scaling resistant ultrasound reflecting surface and back through the industrial fluid to the reference ultrasonic transmitter-receiver wherein the transit time and the known distance between the reference ultrasonic transmitter-receiver assembly and the unheated, scaling resistant ultrasonic transmitter-receiver flush surface are used to calculate the real time velocity of the reference ultrasonic signal.

14. The method of claim 10, wherein the known and fixed distance between the reference ultrasonic transmitter-receiver flush surface and the scaling resistant surface is used to calculate the real time velocity of the ultrasonic signal through the industrial fluid.
